(19) United States
(12) Patent Application Publication
(10) Pub. No.: US 2019/0047895 A1
(43) Pub. Date: Feb. 14, 2019

(54) METHODS AND APPARATUS FOR EDGE SURFACE INSPECTION OF A MOVING GLASS WEB

(71) Applicant: CORNING INCORPORATED, CORNING, NY (US)

(72) Inventors: David Joseph Kuhn, Prattsburgh, NY (US); Philip Robert LeBlanc, Corning, NY (US); AJayantha Senawiratne, Horseheads, NY (US); Weihua Sun, Corning, NY (US)

(21) Appl. No.: 16/080,135

(22) PCT Filed: Feb. 23, 2017
(86) PCT No.: PCT/US2017/019006

§ 371 Date: Aug. 27, 2018

Related U.S. Application Data
(60) Provisional application No. 62/299,750, filed on Feb. 25, 2016.

(51) Int. Cl. C03B 33/023; C03B 33/09; G01N 21/896; G06T 7/00

(52) U.S. Cl. CPC C03B 33/0235; C03B 33/091; G06T 2207/30108; G06T 7/0004; G01N 21/896

(57) ABSTRACT

Methods and apparatus provide for sourcing a glass web, the glass web having a length and a width transverse to the length; moving the glass web from the source to a destination in a transport direction along the length of the glass web; cutting the glass web, at a cutting zone, along the length of the glass web into at least first and second glass ribbons as the glass web is moved in the transport direction from the source to the destination, such that respective first and second edge surfaces are produced on the first and second glass ribbons; and optically inspecting at least one of the first and second edge surfaces in real-time as the first and second glass ribbons of the glass web are moved in the transport direction to the destination.

### CROSS-REFERENCE TO RELATED APPLICATIONS

This application claims the benefit of priority under 35 U.S.C. § 119 of U.S. Provisional Application Ser. No. 62/299,750 filed on Feb. 25, 2016, the content of which is relied upon and incorporated herein by reference in its entirety.

### BACKGROUND

The present disclosure relates to methods and apparatus for inspecting edge surface quality of a moving web of glass material.

Continuous processing of ultra-thin glass web, for example glass web measuring less than or equal to about 0.3 mm in thickness, is a relatively new field and presents a number of manufacturing challenges. A conventional process for producing such webs includes employing a roll-to-roll technique in which a glass web is conveyed in a continuous transport between a supply roll and a take-up roll. To produce final products, for example glass for flat panel displays or other products, the glass web must be cut or sliced during the roll-to-roll conveyance of the glass web. A laser cutting technique (or other suitable cutting technique) may be employed to slit the glass web to remove bead portions (i.e., thickened portions that are located at the peripheral edges of the glass web that occur when forming the web) during transport. The glass web may also be cut during roll-to-roll conveyance to achieve desired width dimensions for later processing.

The final piece parts delivered to customers often must exhibit very smooth, particle free edges, with minimal edge defects and/or edge corner defects. After removal of the beads and/or cutting the web to width, however, the quality of the edge surface(s) might not be within tolerances. Conventional approaches for cutting and inspecting the glass web, however, have not provided the ability to inspect and evaluate edge surface quality during the roll-to-roll conveyance of the glass web in a continuous transport system.

Accordingly, there are needs in the art for new methods and apparatus for inspecting edge surface quality of a moving web of glass material.

### SUMMARY

The present disclosure relates to methods and apparatus for inspecting edge surface quality of a moving web of glass material, for example during the removal of beads and/or during the cutting of the glass web to desired widths.

Whether a laser cutting technique is employed or some other cutting technique, edge surface defects generally occur randomly as they are the result of imperfect process parameters and/or varying conditions during the cutting and transport process. It is generally understood that edge surface defect types may be classified into the following categories: chips (see, FIG. 1), hackle lines (see, FIG. 2), Wallner lines (see, FIG. 3), and arrest lines (see FIG. 4). Other categories of edge surface defect types (which are not illustrated) include frictive damages and scratches.

During a roll-to-roll, or continuous transport cutting process, it would be highly advantageous to be able to perform real-time edge surface inspection, quantification of edge surface defects (or quantification of edge surface quality). The prior state of the art, however, does not permit real-time edge surface inspection and quantification capabilities. Thus, edge surface inspection and quality assessments are randomly checked off-line using suitable techniques, for example by way of automated high resolution microscope systems, which can generate edge surface images for specially prepared samples. Such systems, however, have proven to exhibit very limited speeds and, thus, are used for a very small number of samples. Moreover, the images produced by the commercially available high resolution microscope systems must be interpreted by a trained scientist, which is very tedious, expensive, and exacerbates an already slow process. Due to the tedious and excessively slow inspection techniques available to production personnel, many operators prefer to simply slide their fingers along the edge surface of a cut glass web to obtain what limited edge surface quality information may be available from a tactile inspection.

Whether a sophisticated high resolution microscope system is employed or whether a tactile inspection is performed, the results are either for far fewer than a 100% real-time inspection or are so crude as to be of questionable value. Consequently, present production techniques fail to include real-time, systematic and reliable defect quantification in connection with determining edge surface quality in continuous conveyance glass web cutting processes.

In accordance with one or more embodiments herein, new methods and apparatus have been developed in which an inline glass edge inspection system is employed to measure, identify, classify, and quantify edge surface defects in the glass web in real time. The inspection system may include back lit illumination of the edge surface of the glass web, high resolution optical imaging of such edge surface, mechanically driven in situ auto-focusing, and a defect classification and quantification algorithm. The defect classification and quantification algorithm analyzes the brightness contrast of the edge surface images to identify, classify, and quantify various defects on or in the edge surfaces.

Advantages and benefits of one or more embodiments herein include any of the following:

Can provide in situ process feedback capability (to change process parameters) for a glass web roll-to-roll cutting process involving edge slitting, bead removal, edge grinding, and/or chamfering.

Can provide 100% inspection of edge surfaces, which allows for the capture of transient events, trends, etc.

Can provide instantaneous feedback to the glass edge shaping and separation processes, which permits modifications to processing parameters to improve edge surface quality.

Can provide a quality control tool to capture statistical drift of a continuous conveyance process.

Can provide a non-destructive, non-intrusive, automated edge surface inspection process, which is tolerant of three dimensional (3D) glass web motion.

In accordance with one or more embodiments, methods and apparatus disclosed herein may provide for: sourcing a glass web, the glass web having a length and a width transverse to the length; continuously moving the glass web from the source to a destination in a transport direction (also known as a down-web direction) along the length of the glass web; cutting the glass web, at a cutting zone, along the length into at least first and second glass ribbons as the glass web is moved in the transport direction from the source to the destination, such that respective first and second edge surfaces are produced on the first and second glass ribbons; and optically inspecting at least one of the first and second edge surfaces in real-time as the first and second glass ribbons of the glass web are moved in the transport direction to the destination.

In accordance with one or more embodiments the inspecting operation(s) may include one or more of: (i) taking at least one image of the at least one of the first and second edge surfaces as the first and second glass ribbons of the glass web are moved in the transport direction, (ii) extracting one or more features of the at least one of the first and second edge surfaces from the at least one image, and (iii) detecting one or more defects, and identifying one or more types of the one or more defects, based on the one or more extracted features.

The types of the one or more defects may include chips, hackles, Wallner lines, arrest lines, frictive damage, and scratches.

The methods and apparatus may further provide for one or more of: directing incident light onto and through an opposing edge of at least one of the first and second glass ribbons that is laterally opposite to (also known as a cross-web direction from) the at least one of the first and second edge surfaces; propagating the light through the at least one of the first and second glass ribbons, transversely with respect to the transport direction, such that the light exits through the at least one of the first and second edge surfaces; and directing an optical axis of an imaging sensor substantially perpendicularly toward the at least one of the first and second edge surfaces, to receive the light exiting the at least one of the first and second edge surfaces, such that the imaging sensor produces the at least one image.

Additionally or alternatively, the methods and apparatus may further provide for one or more of: monitoring a distance from the imaging sensor (and/or a reference position) to the at least one of the first and second edge surfaces as the first and second glass ribbons of the glass web are moved in the transport direction to the destination; and automatically adjusting a position of focus of the imaging sensor as a function of the distance such that the at least one image remains in focus.

In accordance with one or more embodiments, the methods and apparatus may further provide for detecting the one or more defects, and identifying the one or more types of the one or more defects, to include one or more of: enhancing one or more defect features as compared to background features in the at least one image; applying a segmentation process to the enhanced defect features to separate high contrast features from lower contrast features, thereby producing a plurality of segments; and extracting features from each of the plurality of segments by analyzing each segment as to one or more of the following features: (i) a total area of the segment, (ii) an eccentricity and/or elongation of the segment, (iii) a width of the segment, (iv) a height of the segment, and (v) a fill ratio of the segment.

Additionally or alternatively, the methods and apparatus may further provide for determining and identifying the one or more types of the one or more defects based on the analysis of the segments.

For example, a determination that one or more of the segments represent a chip when one or more of: (i) a total area of the one or more segments is relatively large, within a range of relatively small to relatively large, (ii) an eccentricity and/or elongation of the one or more segments is relatively low, within a range of relatively low to relatively high, and (iii) a fill ratio of the one or more segments is relatively high, within a range of relatively low to relatively high.

By way of further example, a determination that one or more of the segments represent a hackle when one or more of: (i) a width of the one or more segments is relatively small, within a range of relatively small to relatively large, and (ii) a location of the one or more segments is relatively close to a periphery of the edge surface.

By way of further example, a determination that one or more of the segments represent a Wallner line when one or more of: (i) a total area of the one or more segments is relatively large, within a range of relatively small to relatively large, (ii) an eccentricity and/or elongation of the one or more segments is relatively high, within a range of relatively low to relatively high, and (iii) a height of the one or more segments is relatively small, within a range of relatively small to relatively large.

By way of further example, a determination that one or more of the segments represent an arrest line when one or more of: (i) a total area of the one or more segments is relatively large, within a range of relatively small to relatively large, (ii) an eccentricity and/or elongation of the one or more segments is relatively high, within a range of relatively low to relatively high, (iii) a width of the one or more segments is relatively small, within a range of relatively small to relatively large, and (iv) a height of the one or more segments is relatively large, within a range of relatively small to relatively large.

Additionally or alternatively, the methods and apparatus may further provide for automatically adjusting one or more parameters of cutting the glass web at the cutting zone based on the detection and identification.

By way of example, the cutting of the glass web at the cutting zone may include heating an elongated zone of the glass web using a laser delivery apparatus followed by cooling the heated portion of the glass web to propagate a fracture in a direction opposite to the transport direction, thereby producing the first and second ribbons. In such an embodiment, the one or more parameters of the cutting of the glass web may include a power level of incident laser light from the laser delivery apparatus, and a focus of the incident laser light from the laser delivery apparatus.

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1 is a magnified image of an edge surface of a cut glass web, where the image includes features indicating that the edge surface has a defect, for example a chip;

FIG. 2 is a magnified image of an edge surface of a cut glass web, where the image includes features indicating that the edge surface has a defect, for example a hackle;

FIG. 3 is a magnified image of an edge surface of a cut glass web, where the image includes features indicating that the edge surface has a defect, for example a Wallner line;

FIG. 4 is a magnified image of an edge surface of a cut glass web, where the image includes features indicating that the edge surface has a defect, for example an arrest line;

FIG. 5 is a top schematic view of an apparatus for cutting a glass web into at least two glass ribbons;

FIG. 6 is a side, elevational schematic view, which illustrates further details of the apparatus 100, including a transport mechanism, a cutting mechanism, and an edge surface inspection mechanism;

FIG. 7 is a schematic illustration of an embodiment of the cutting mechanism of FIG. 6 in which an optical delivery apparatus and a cooling fluid source operate to propagate a fracture in the glass web to produce the at least two glass ribbons;

FIG. 8 is a schematic illustration of an embodiment of the edge surface inspection mechanism of FIG. 6, including a light source, an imaging sensor, and an auto-focus mechanism;

FIG. 9 is a schematic illustration (top view) of a ribbon of glass that has been cut, thereby producing an edge surface for inspections, and where the light source is incident on an opposing edge of the ribbon of glass, propagates through the ribbon of glass, and exits the edge surface of the ribbon of glass for detection;

FIG. 10 is a schematic illustration (side view) of the ribbon of glass of FIG. 9;

FIG. 11 is a collection of images representing respective outputs of an algorithm for optically inspecting an edge surface of a cut ribbon of glass, detecting one or more defects, and identifying one or more types of the one or more defects; and

FIG. 12 is a collection of respective pairs of images, each pair including an image of an edge surface of a cut ribbon of glass, and an output image representing a classification of one or more detected and identified defects.

### DETAILED DESCRIPTION OF THE PREFERRED EMBODIMENTS

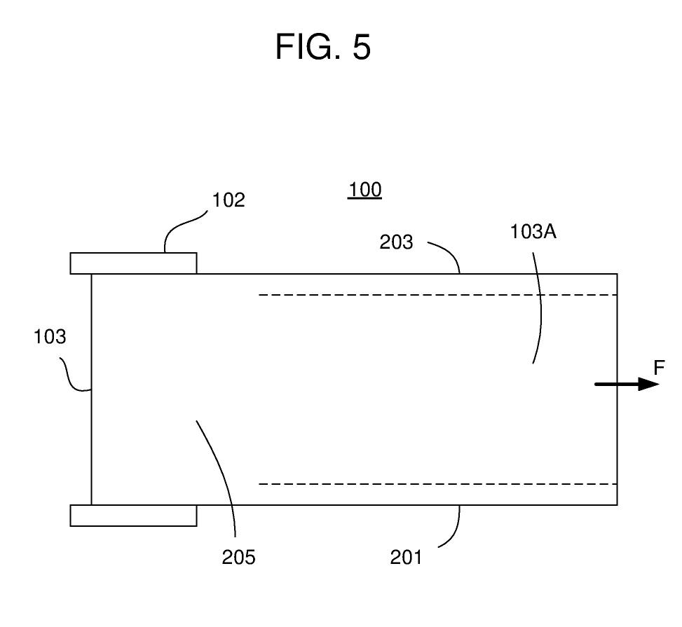

With reference to the drawings wherein like numerals indicate like elements there is shown in FIG. 5 a top schematic view of an apparatus 100 for cutting a glass web 103, for example, along one or both of the illustrated dashed lines. The illustrated dashed lines are intended to show cutting lines for removing beads, however, other and/or additional cutting lines may be employed to cut the glass web into one or more glass ribbons, for example glass ribbon 103A.

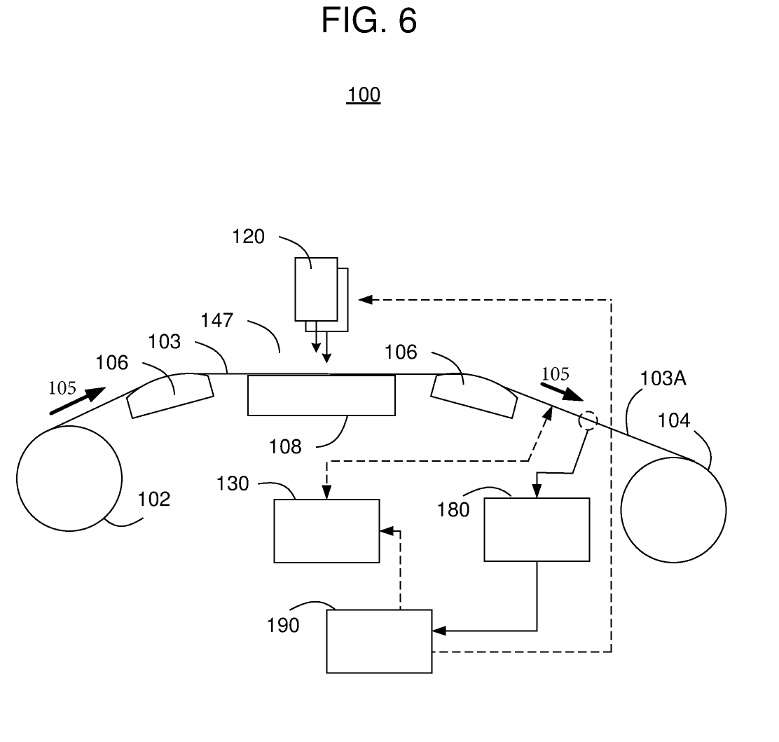

FIG. 6 is a side, elevational schematic view, which illustrates further details of the apparatus 100. In general, the apparatus 100 operates to source the glass web 103 and continuously move the glass web 103 from the source 102 to a destination zone in a transport direction 105 (the down-web direction) along the length of the glass web 103 (illustrated by the arrows 105). During the transport of the glass web 103 from the source 102 to the destination zone, the glass web 103 is cut in a cutting zone 147 into the glass ribbon 103A. (For purposes of clarity, FIG. 6 does not show the transport path(s) for sections of the glass web 103 created by the removal of the beads.) The glass web 103 has a length (in the transport direction) and a width transverse to the length, and the width of the glass ribbon 103A will be smaller than the overall width of the glass web 103.

With reference to FIG. 5, the glass web 103 may be provided by a wide range of sources, for example a down draw glass forming apparatus (not shown) in which a trough having a forming wedge permits molten glass to overflow the trough and flow down opposite sides of the forming wedge, where the respective flows are subsequently fused together as they are drawn off the forming wedge. This fusion down drawn process produces a glass web 103, which may be introduced into the transport mechanisms of the apparatus 100 for cutting. It is noted that the glass web 103 would typically include a pair of opposed edge portions 201, 203 and a central portion 205 spanning between the opposed edge portions 201, 203. Due to the down draw fusion process, the edge portions 201, 203 of the glass ribbon may have corresponding beads of a thickness that is typically greater than a thickness of the central portion 205 of the glass web 103. The beads may be removed using the cutting techniques disclosed herein or other more conventional approaches.

As will be discussed in greater detail later herein, it is very desirable that the resulting edge surface(s) of the glass ribbon 103A (e.g., from removing the bead(s) and/or cutting the glass web 103 to a specified width) have very high quality, and that any significant degradation of the quality of the edge surface(s) should be detected, defects classified, and corrective actions taken. Therefore, as schematically illustrated in FIG. 6, the apparatus 100 includes an edge surface inspection mechanism 180 that operates to inspect, detect defects, and identify the type(s) of such defects in real-time as the glass web 103 is conveyed and cut.

The source 102 of glass web 103 may include a spool, onto which the glass web 103 was first wound, e.g., following a fusion down draw process. Typically, the spool used as source 102 would be provided with a relatively large diameter to present a relatively low bending stress to accommodate the characteristics of the glass web 103. Once coiled onto the spool used as source 102, the glass web 103 may be uncoiled from that spool and introduced into the transport mechanisms of the apparatus 100.

The destination zone of the apparatus 100 may include any suitable mechanisms for accumulating the glass ribbon 103A (and waste beads, not shown). In the example illustrated in FIG. 6, the destination zone includes a spool 104 for receiving and winding the glass ribbon 103A. The spool 104 should be provided with a relatively large diameter to present a suitable bend radius in order to accommodate the characteristics of the glass ribbon 103A.

The apparatus 100 includes a transport mechanism having a number of individual elements that cooperate to continuously move the glass web 103 from the source 102, for example a spool of wound glass, to the destination spool 104 in the transport direction. This transport function may be accomplished without degrading the desirable characteristics of the ribbon edge surfaces, as produced from the cutting operation, or either (pristine) major surface of the central portion 205 of the glass web 103 and/or ribbon 103A. In short, the transport function is accomplished without degrading desirable characteristics of the glass ribbon 103A.

By way of example, the apparatus 100 may include a plurality of noncontact support members 106, 108, rollers, etc., to guide the glass web 103 and glass ribbon 103A through the system from the source 102 to the destination spool 104. The non-contact support members 106, 108 may be flat and/or curved to achieve desirable directional conveyance of the respective work pieces. Each of the noncontact support members 106, 108 may include a fluid bar and/or a low friction surface to ensure the glass web 103 and glass ribbon 103A are suitably conveyed through the system without damage or contamination. When a given non-contact support member 106, 108 includes an fluid bar, such element includes a plurality of passages and ports configured to provide a positive fluid pressure stream (for example air), and/or a plurality of passages and ports configured to provide a negative fluid pressure stream, to the associated surface of the glass web 103 and/or glass ribbon 103A to create an air cushion for such noncontact support. A combination of positive and negative fluid pressure streams may stabilize the glass web 103 and glass ribbon 103A during transport through the system.

Optionally, a number of lateral guides (not shown) may be employed proximate to the edge portions 201, 203 of the glass web 103 and/or the edge surfaces of the glass ribbon 103A to assist in orienting the glass web 103 and/or glass ribbon 103A in a desired lateral position relative to the transport direction. For example, the lateral guides may be implemented using rollers that engage a corresponding one of the opposed edge portions 201, 203 of the glass web 103, and/or one or more edge surfaces of the glass ribbon 103A. Corresponding forces applied to the edge portions 201, 203 by the corresponding lateral guides may shift and align the glass web 103 in the proper lateral orientation as the glass web 103 is conveyed through the apparatus.

Due to its high modulus, notch sensitivity and brittleness, however, it is beneficial for the glass web 103 to have very consistent and symmetrical stress and strain fields in the cutting zone 147 in order to exhibit suitable edge characteristics (minimal fractures) after cutting. Therefore, the apparatus 100 includes a tensioning mechanism 130 (for example, as would be understood by one of ordinary skill in the art, a dancer, a web accumulator, a roller with a break) operating to provide consistent and symmetric stress fields and strain fields in the cutting zone 147. In accordance with one or more embodiments herein, tensioning is carefully and independently (from edge portions 201, 203) controlled in the glass ribbon 103A in order to achieve consistent and symmetric stress and strain fields. This approach is intended to result in a very fine, particle free edge surfaces that minimizes edge and/or edge corner defects.

In order to achieve the aforementioned tensioning functionality, the tensioning mechanism 130 monitors the tension, determines whether the tension is within prescribed limits, and varies the force based on the determination to ensure the tension is within prescribed limits. As schematically illustrated in FIG. 6 via dashed lines, the tensioning mechanism 130 includes one or more means for sensing the tension in the glass ribbon 103A and a means for changing such tension if such tension is outside a prescribed range.

The apparatus 100 further includes a cutting mechanism 120 that cuts or severs the glass web 103 in the cutting zone 147 as the glass web 103 passes over, for example, the noncontact support member 108. As will be described in more detail later herein, the cutting mechanism 120 may make a single cut or may simultaneously make multiple cuts; however, a significant characteristic of the cutting process is that the resultant glass ribbon 103A (and/or further numbers of ribbons) will exhibit edge surface(s) that are subject to defects, for example chips, hackles, Wallner lines, arrest lines, frictive damage, and scratches.

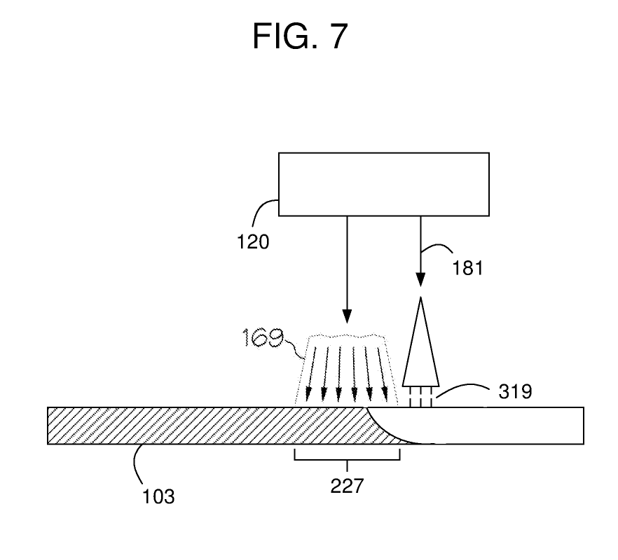

With reference to FIG. 7, in one or more embodiments, the cutting mechanism 120 may include an optical delivery apparatus for heating an elongated zone of the glass web 103, and a cooling fluid source that applies coolant to the heated portion of the glass web 103 to propagate a fracture in a direction opposite to the transport direction, thereby producing the glass ribbons 103A. In accordance with one or more embodiments, the cutting mechanism 120 may include multiple heating/cooling apparatus arranged across the glass web 103 to produce multiple simultaneous cuts. The positions of the respective heating/cooling apparatus are adjustable in order to meet particular customer requirements as to the width of the glass ribbon 103A.

The optical delivery apparatus may include a radiation source, for example a laser, although other radiation sources may be employed. The optical delivery apparatus may further include other elements to shape, adjust direction and/or adjust the intensity of an optical beam, for example one or more polarizers, beam expanders, beam shaping apparatus, etc. Preferably, the optical delivery apparatus produces a laser beam 169 having a wavelength, power, and shape suitable for heating the glass web 103 at a location on which the laser beam 169 is incident.

It has been found that a laser beam 169 of significantly elongated shape works well. The boundary of the elliptical footprint of the laser beam 169 may be determined as the point at which the beam intensity has been reduced to 1/e² of its peak value. The elliptical footprint may be defined by a major axis that is substantially longer than a minor axis. In some embodiments, for example, the major axis may be at least about ten times longer than the minor axis. However, the length and width of an elongated radiation heated zone 227 are dependent upon the desired severing speed, desired initial crack size, thickness of the glass ribbon, laser power, etc., and the length and width of the radiation zone may be varied to suit the particular cutting conditions.

The cooling fluid source 181 operates to cool the heated portion of glass web 103 by application of cooling fluid, preferably a jet of fluid, for example though a nozzle or the like. The geometry of the nozzle, etc., may be varied to suit the particular process conditions. The cooling fluid may include water, however, any other suitable cooling fluid or mixture may be employed that does not damage the glass web 103. The cooling fluid may be delivered to the surface of the glass web 103 to form a cooling zone 319, where the cooling zone 319 may trail behind the elongated radiation zone 227 to propagate a fracture (initiated by an induced crack). The combination of heating and cooling effectively severs the glass web 103 to create the glass ribbon 103A, while minimizing or eliminating undesired residual stress, micro-cracks or other irregularities in edge surface(s) created by the cut, which result in the aforementioned defects.

As noted above, the apparatus 100 includes the inspection mechanism 180 to address the problem of such defects in the edge surface(s) or the glass ribbon 103A. The inspection mechanism 180 optically inspects one or more edge surfaces of the glass ribbon 103A (and/or further glass ribbons) as the glass web 103 is moved in the transport direction 105 to the destination. From a functional point of view, the inspection mechanism 180 executes actions, including: (i) taking at least one image of the edge surface(s) as the glass ribbon 103A is moved in the transport direction 105, (ii) extracting one or more features of the edge surface(s) from the at least one image, and (iii) detecting one or more defects, and identifying one or more types of the one or more defects, based on the one or more extracted features.

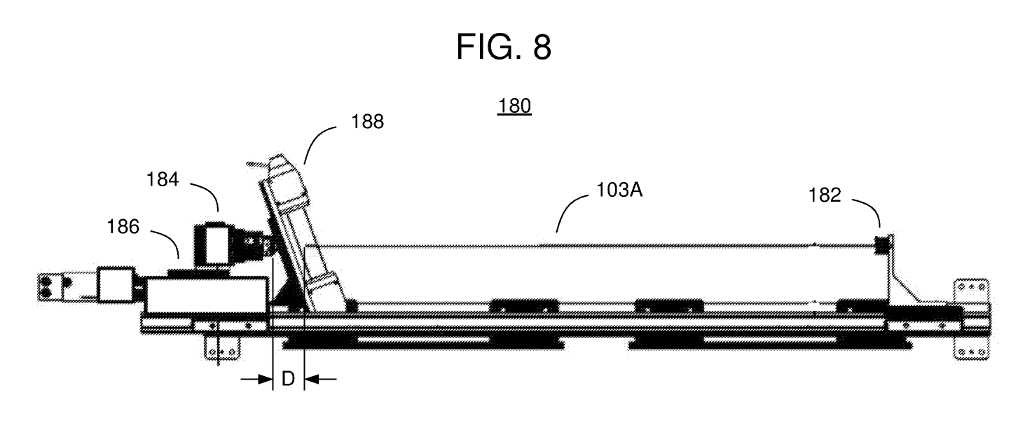

With reference to FIGS. 6 and 8, one or more embodiments of the inspection mechanism 180 may include one or more light sources 182, one or more imaging sensors 184, one or more auto-focus mechanisms 186, one or more motion sensors 188, and a processing and control unit 190. For purposes of clarity and brevity, the embodiments below are shown and described as inspecting one of the edge surfaces of the glass ribbon 103A (resulting from a cut). One skilled in the art, however, will appreciate that the inspection mechanism 180 may be modified to inspect more than one edge surface simply by incorporating multiple light sources 182, imaging sensors 184, auto-focus mechanisms 186, motion sensors 188, and/or processing and control units 190 in order to evaluate such edge surfaces in real time.

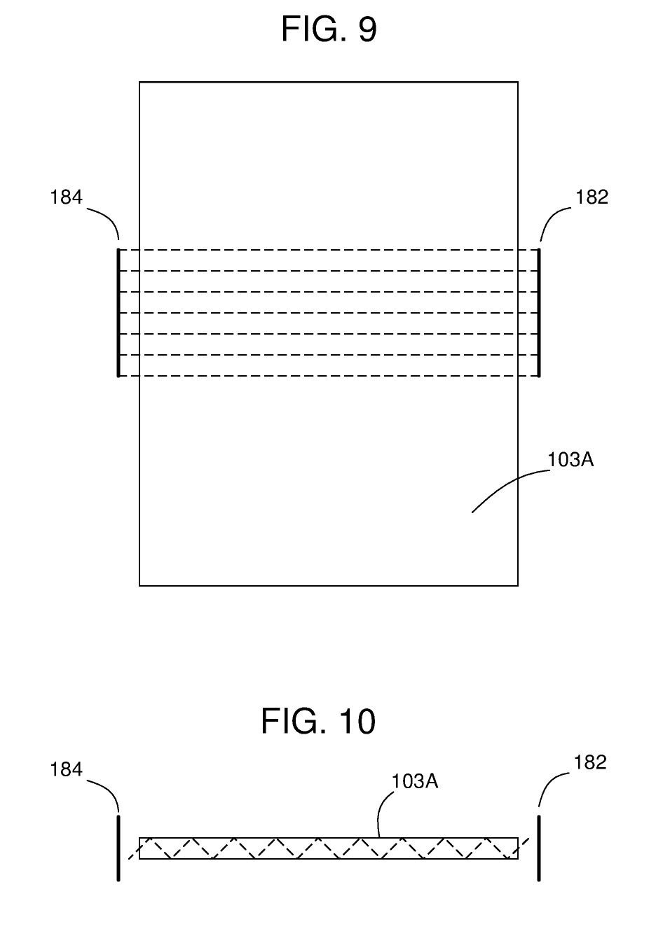

The light source 182 directs incident light onto and through a proximal edge surface of the glass ribbon 103A, which is an opposing edge of the glass ribbon 103A that is laterally opposite to (cross-web from) the edge surface that is being inspected (a distal edge surface). As illustrated in FIGS. 9 and 10, incident light from the light source 182 propagates through the glass ribbon 103A, transversely with respect to the transport direction, such that the light exits through the edge surface being inspected. Uniform illumination of the proximal edge surface of the glass ribbon 103A is very desirable in detecting micro scale defect features on the edge surface being inspected. In addition, it is also desirable for the imaging sensor 184 and processing (discussed later) to be robust enough to tolerate some level of vertical vibration of the glass ribbon 103A during the inspection process. Therefore to provide uniform illumination and to tolerate vertical vibration, one or more embodiments may employ a light source 182 that includes a bright field (transmission) configuration using a line shaped light emitting diode (LED) light source (see, FIGS. 9-10). In this configuration, strong waveguide action (see FIG. 10) allows light to travel through the glass ribbon 103A quite efficiently and hence provide bright and uniform illumination of the edge surface being inspected. Furthermore, the waveguide action of the glass ribbon on the incident light produces an illumination of the edge surface being inspected that is less sensitive to vertical vibrations of the glass ribbon 103A.

In one or more embodiments, it is considered very desirable to generate a “brightfield” image of the defects on and/or in the edge surface of the glass ribbon 103A. Fine grayscale features present under brightfield illumination enable more accurate sizing and classification of edge features than high-contrast geometries. Notably, however, “darkfield” geometries can be very useful and effective when sensitive detection of features is desired, for instance when using low optical magnification optics to detect particles or glass chips. In both cases, care should be taken to maximize the dynamic range of features on the resulting images, including preventing saturation and/or bottoming out of the features, whereby the details of the defect features are lost within poor contrast. It has been found that good results may be obtained when the imaging sensor 184 has 8-bits of grayscale and sufficient lighting is provided to interact with the defect features; indeed, such a combination has been found to produce a high contrast image. Based on use of the aforementioned high brightness LED and efficient lighting geometry (due to the waveguide approach), it may be a relatively simple matter to position the LED to within a few centimeters of the proximal edge surface of the glass ribbon 103A. Nevertheless, light diverges heavily from a bare LED. Thus, one may employ one or more additional optical elements between the light source (whether an LED, halogen lamp, laser, or any other illuminator) and the proximal edge surface of the glass ribbon 103A to increase coupling efficiency or otherwise condition the lighting. For instance, one may employ a condensing lens to collect more light coming from the light source and focus the light to a point at or near the proximal edge surface of the glass ribbon 103A. This may greatly increase brightness. Additionally and/or alternatively, one may employ a diffuser between the light source and the proximal edge surface of the glass ribbon 103A to even the output spatially. Still further, a color filter and/or a polarizer may be employed to affect the light reaching the imaging sensor 184 to target some property of the defects in question.

To obtain coupling of the light from the light source into the proximal edge of the glass ribbon 103A (To achieve waveguiding) it is desirable to have a suitable edge finish (for example a straight, mirror-like finish attained via the aforementioned laser cut). In contrast, when the proximal edge of the glass ribbon 103A exhibits the characteristics of a ground edge, an attempt to couple light from the light source into the proximal edge of the glass ribbon 103A exhibits high loss because the edge scatters a lot of light. To compensate, one may increase the intensity of the light source to provide sufficient illumination for adequate defect contrast, or instead use a reflection geometry.

The imaging sensor 184 is preferably provided such that an optical axis thereof is directed substantially perpendicularly toward the edge surface being inspected. The imaging sensor 184 receives the light exiting the edge surface being inspected and produces at least one image of the edge surface. By way of example, the imaging sensor 184 is preferably a high resolution image acquisition device, with sufficient speed to be effective despite a conveyance speed of the glass ribbon 103A in the range of about 200 mm/s or higher, and a relatively large field of view (with reference to the edge surface dimensions). To achieve a high resolving power, the imaging sensor 184 may employ a high numerical aperture (NA) lens (e.g., above 0.2) and a light sensitive sensor (e.g., a charge couple device (CCD) array, for example a CCD having 7 um per pixel resolution). High NA optics are beneficial for highlighting fine defect features on the edge surface (for example hackle lines). High NA optics also are characterized by small depths-of-field (DOF), which may be less than about 50 μm. Consequently, as discussed below, one should very carefully measure, track, and adjust for any change in distance from the imaging sensor 184 to the edge surface to remain within the aforementioned DOF.

With reference to FIG. 8, to accommodate practical environments in which a distance, D, from the edge surface being inspected to the imaging sensor 184 is susceptible to variation as the glass ribbon 103A moves through the system, the inspection mechanism 180 may include the automatic focus mechanism 186. By way of example, the automatic focus mechanism 186 may include a distance sensor that monitors the distance from the imaging sensor 184 (and/or some reference position) to the edge surface being inspected as the glass ribbon 103A moves in the transport direction to the destination. The automatic focus mechanism 186 automatically adjusts a position of focus of the imaging sensor 184 as a function of the distance D such that the at least one image remains in focus. By way of example, the automatic focus mechanism 186 may include a motion stage that automatically adjusts a position of the imaging sensor 184 relative to the edge surface as a function of the distance D to adjust the aforementioned position of focus (i.e., to maintain a constant distance D) such that the at least one image remains in focus.

Alternatively and/or additionally, the automatic focus mechanism 186 may interface with an adjustable lens system of the imaging sensor 184 to automatically adjust the lens system as a function of a varying distance D to adjust the aforementioned focal length. When the imaging sensor 184 includes such an adjustable lens system, the optics of the lens itself may be adjusted to vary a focal length of the lens, and therefore the motion stage (and the resultant translational movement of the imaging sensor 184 towards and/or away from the edge surface of the glass ribbon 103A) may be avoided. Indeed, the position of the imaging sensor 184 may remain fixed. Nevertheless, adjustments in the focal length of the imaging sensor 184 may be made to account for variations in the distance D from the imaging sensor 184 to the edge surface of the glass ribbon 103A during conveyance thereof.

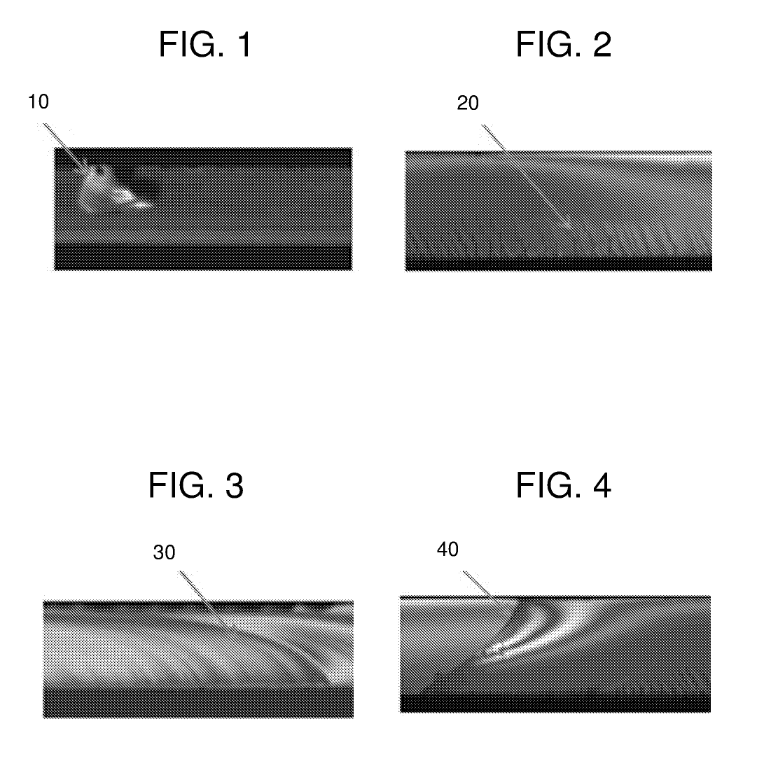

Examples of the images of the edge surface being inspected have been presented above (FIGS. 1-4), which may include such defects as chips, hackles, Wallner lines, arrest lines, frictive damage, and scratches. To detect and identify the type(s) of defects that may be present in the one or more images of the edge surface being inspected, the inspection mechanism 180 may include the processing and control unit 190, which carries out an algorithm for analyzing the features of the one or more images.

By way of example, the processing and control unit 190 may include a computer processor operating under the control of a computer program, which may be stored in a digital storage medium. When the computer program is executed by the computer processor, the computer program causes the computer processor to carry out the actions of detecting the one or more defects, and identifying the one or more types of the one or more defects. More specifically, the algorithm may include one or more of: (i) enhancing one or more defect features as compared to background features in the at least one image; (ii) applying a segmentation process to the enhanced defect features to separate high contrast features from lower contrast features, thereby producing a plurality of segments; and (iii) extracting features from each of the plurality of segments by analyzing each segment as to one or more predetermined features. Such extracted features may include: (i) a total area of the segment, (ii) an eccentricity and/or elongation of the segment, (iii) a width of the segment, (iv) a height of the segment, and (v) a fill ratio of the segment.

Further details as to how to enhance one or more defect features, apply a segmentation process, and extract features from each of the plurality of segments will be provided later herein. At present, however, it has been discovered that the above-noted features of the segments may be used to detect and identify types of defects.

For example, the processing and control unit 190 of the inspection mechanism 180 employs the algorithm to make a determination that one or more of the segments represent a chip when one or more of: (i) a total area of the one or more segments is relatively large, within a range of relatively small to relatively large, (ii) an eccentricity and/or elongation of the one or more segments is relatively low, within a range of relatively low to relatively high, and (iii) a fill ratio of the one or more segments is relatively high, within a range of relatively low to relatively high.

Additionally or alternatively, the processing and control unit 190 of the inspection mechanism 180 may employ the algorithm to make a determination that one or more of the segments represent a hackle when one or more of: (i) a width of the one or more segments is relatively small, within a range of relatively small to relatively large, and (ii) a location of the one or more segments is relatively close to a periphery of the edge surface.

Additionally or alternatively, the processing and control unit 190 of the inspection mechanism 180 may employ the algorithm to make a determination that one or more of the segments represent a Wallner line when one or more of: (i) a total area of the one or more segments is relatively large, within a range of relatively small to relatively large, (ii) an eccentricity and/or elongation of the one or more segments is relatively high, within a range of relatively low to relatively high, and (iii) a height of the one or more segments is relatively small, within a range of relatively small to relatively large.

Additionally or alternatively, the processing and control unit 190 of the inspection mechanism 180 may employ the algorithm to make a determination that one or more of the segments represent an arrest line when one or more of: (i) a total area of the one or more segments is relatively large, within a range of relatively small to relatively large, (ii) an eccentricity and/or elongation of the one or more segments is relatively high, within a range of relatively low to relatively high, (iii) a width of the one or more segments is relatively small, within a range of relatively small to relatively large, and (iv) a height of the one or more segments is relatively large, within a range of relatively small to relatively large.

With reference to FIG. 6, the processing and control unit 190 of the inspection mechanism 180 may provide a feedback mechanism that automatically adjusts one or more parameters of the cutting mechanism 120, the cutting mechanism cutting the glass web 103 at the cutting zone based on the detection and identification of defects. For example, in embodiments where the cutting mechanism 120 includes a laser delivery apparatus, the one or more parameters of the cutting mechanism 120 may include a power level of incident laser light from the laser delivery apparatus, and/or a focus of the incident laser light 181 from the laser delivery apparatus.

Turning now to further details concerning how the algorithm within the processing and control unit 190 determines the existence of and types of defects on the edge surface being inspected, a number of features of various types of defects will be discussed.

With reference to FIG. 1, a chip is discernible as a defect chipped off a portion of the edge surface due to concentrated loads. Chips can be recognized in the image by a human visual inspection; however, a chip can be made of several clustered blobs, which presents a challenge to detection and identification using a machine algorithm. A simple form of an oval-shaped chip is generally composed of a bright region and a dark region resulting from the aforementioned illumination. In practical terms, several chips are often located together, which produces a number of blobs in the image of the edge surface being inspected. In general, features of a chip typically include: strong contrast, large size (height, width and/or area), and low eccentricity.

With reference to FIG. 2, hackle lines are defects that separate portions of the crack surface, each of which has rotated from the original crack plane in response to a lateral rotation or twist in the axis of principal tension. Hackle lines generally appear in a group, starting from a periphery of the edge surfaces and propagating within the glass ribbon 103A. Hackle lines are very thin structures that pose a challenge for the inspection mechanism 180. In general, features of a hackle line typically include: strong contrast, small size (height, width and/or area), starts from a periphery of the edge of the glass ribbon 103A, very thin (small width versus large height), lines being spatially segregated from one another.

With reference to FIG. 3, a Wallner line is a rib-shaped mark with a wavelike contour caused by a temporary excursion of the crack front out of plane in response to a tilt in the axis of principal tension. A Wallner line may also form from passage of the crack front through a region with a locally shifted stress field, as at an inclusion, pore, or surface discontinuity. In optical images taken of the edge surface, Wallner lines appear to have lower contrast and resemble line-like structures. According to current understandings, Wallner lines are indications of the existence of vibration or mechanical shock in the manufacturing process as the glass web 103 moves in the transport direction. In general, features of Wallner lines typically include: weak contrast, large size (height, width and/or area), and low eccentricity.

With reference to FIG. 4, an arrest line is a sharp line on the edge surface defining the crack front shape of an arrested or momentarily hesitated crack prior to resumption of crack propagation under a more or less altered stress configuration. An arrest line generally represents a stress change across the glass web 103, which may reduce the overall strength. An arrest line spans across the edge surface extending to the two major surfaces of the glass ribbon 103A, and has a line shape structure, which manifests as a high eccentricity in the image of the edge surface. In addition, a strong contrast of intensity resides across the arrest line in the image. These features are used in the algorithm to differentiate arrest lines from other types of defects. In general, features of an arrest line typically include: strong contrast, large size (height, width and/or area), high eccentricity, and extension across most if not all of the edge surface of the glass ribbon 103A.

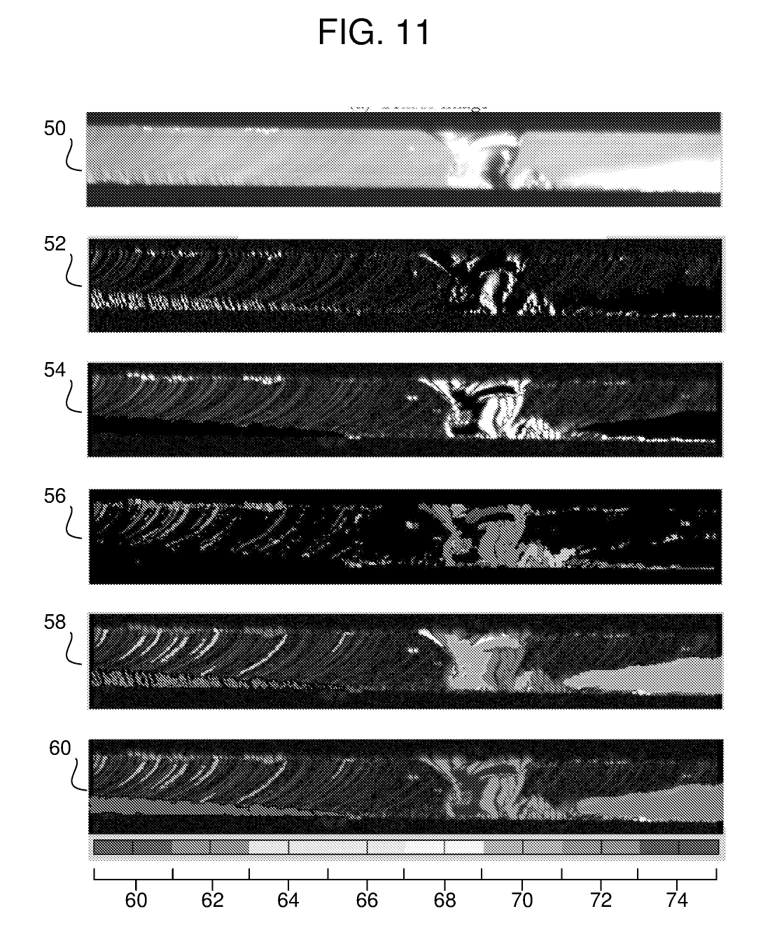

The one or more portions of the algorithm that identify the types of defects within the one or more images of the edge surface generally include four modules; namely, a feature enhancement module, a segmentation module, a feature extraction and classification module, and a grouping module. FIG. 11 is a collection of images representing respective outputs of the above-noted modules. In summary, the modules operate as follows. The feature enhancement module receives the one or more images of the edge surface and highlights defect regions of interests within the image so the segmentation module is more successful in employing a threshold technique to isolate each defect. A set of features are extracted from the isolated defects and fed into a classifier process to produce a blob-level classification. Next, the defects are grouped into logically meaningful (related) blobs. Finally, certain features are extracted from the grouped blobs and are used as final output for decision making as to the type(s) of defects existing on/in the edge surface.

The feature enhancement module serves to highlight the defect regions and suppress background signals within the image of the edge surface (see image 50 in FIG. 11). Indeed, the image of the edge surface is likely to include some illumination non-uniformities due to variations in the lighting and diffraction on the edge surfaces of the glass ribbon 103A. The feature enhancement module is intended to perform a global threshold to map out the defect regions on the image by performing a local threshold to produce an enhanced difference image (see image 52 in FIG. 11). As noted above, the enhanced difference image results in better image segmentation performance (as discussed in more detail later herein).

The features of the defect(s) within the image of the edge surface are represented by intensity changes and may be enhanced, for example, using a difference filter to implements the aforementioned local threshold. One example of such a difference filter is a two scale Haar wavelet filter, which enhances features under different scales. The Haar filter may be represented by the following function:

$${ψ}_{a} ( x ) = \{ \begin{matrix}1 / d & 0 \leq x < d \\ - 1 / d & - d < x < 0 \\ 0 & elsewhere\end{matrix}$$

where it may be assumed that the glass ribbon 103A is being transported along an X-axis, and the variable d corresponds to a scale of interest. A smaller d may enhance fine scale features, for example hackle lines, while a larger d may enhance other defect features (as well as suppressing noise).

An example of a Haar filtered image (see image 52 in FIG. 11) has d=1, which boosts features of hackle lines at the bottom left of the image of the edge surface (compare with image 50 in FIG. 11). Another example of a Haar filtered image (see image 54 in FIG. 11) has d=3, which boosts features of a chip.

The segmentation module receives the enhanced difference image (filtered image) from the feature enhancement module and separates features of defects that appear to be connected in the enhanced difference image. For example, features of Wallner lines may appear to connect with features of hackle lines. As mentioned above, different defect types exhibit features having different contrast intensities. For example, Wallner lines may have very smooth intensity variation while other defects, for example arrest lines or chips, may have very strong intensity changes. On the other hand, the features of different defects may appear to be connected, for example the features of Wallner lines and the features of hackle lines (see, upper left and lower left portions of image 50 in FIG. 11). The segmentation module separates these features such that the different defects may be properly categorized.

By way of example, a dual threshold segmentation technique may be employed to implement the segmentation module, for example using modified hysteresis thresholding. Hysteresis thresholding is a technique to first identify high response pixels, and then recursively connecting adjacent pixels that are above a lower response threshold. In one or more embodiments, hysteresis thresholding may be applied along an X-axis (left-to-right in FIG. 11) of the enhanced difference image, but not along the Y-axis (up and down in FIG. 11), to segment the high response segments without joining weak intensity defects. The use of hysteresis thresholding may thus avoid unwarranted connections between different defects along the Y-axis, produce meaningful segmentation, and reduce clutter along the X-axis. By way of example, the result of segmentation of the Haar filtered image (see, image 54 of FIG. 11) is shown as image 56 in FIG. 11, where different shading (which represent respective colors in a color image) indicates different segments.

The feature extraction and classification module detects and extracts features (called blob features or simply blobs, which are the features of each Binarized Linear Object (BLOB) from each of the segments, which are then used to classify the subject features into types of defects. By way of example, the feature extraction and classification module may be implemented via a binary decision tree classification technique, which permits artisans to observe, test and select key features for satisfactory classification results. The classifier algorithm may be a straight rule-based classification, a neural network, an m-of-n classifier, etc. In this regard, a set of standard and non-standard blob features may be used. The standard features may include one or more of: area, bounding box, eccentricity, orientation, centroid, and/or fill rate (which is the area/convex Area). The non-standard blob features may include one or more of: averaged horizontal integration, effective sub-blob count, effective width, and/or effective degree of elongation. Notably, the non-standard blob features were found to produce better classification results.

The averaged horizontal integration may be defined as the column average of summation along each row. The purpose of the averaged horizontal integration is to reflect overall intensity changes along the X-axis. It has been found to be useful in identifying arrest lines, especially when the intensity change along the X-axis is small but the overall intensity change is strong.

The effective sub-blob may be employed to calculate the actual number of blobs when tightly packed thin lines are recognized as one blob after the threshold process is employed. Calculating the effective number of sub-blobs has been found to be very useful in identifying hackle lines without having to find a way to split the blob into sub-blobs. The technique operates to count the number of false pixels (black) blocks along each row within the blob. The average number of black blocks for all the rows strongly relates to the number of sub-blobs in a super blob. For example, in a segment having three tightly packed blobs (e.g., semi-vertical “white” lines), most rows would have three white blocks separated by two black blocks, indicating the super blob appears as an aggregate of three sub-blobs. The effective width of the sub-blobs may be calculated as the average width (average of row summation, assuming the primary orientation of the defect is vertical, extending along the Y-axis) divided by the effective sub-blob count. The effective width may be a useful feature in identifying hackle lines, since the thickness of a hackle line is very small.

The Effective Degree of Elongation may be considered to be similar to eccentricity. Eccentricity for an ellipse is defined as:

$$e = \sqrt{1 - \frac{{b}^{2}}{{a}^{2}}}$$

where a is the major axis length, b is the minor axis length, and a and b are obtained by fitting an ellipse to the blob. Conveniently, one may use the ratio of b to a (width/height ratio) to indicate the eccentricity of the blob. The eccentricity may be useful in identifying elongated structures; however, eccentricity might not be accurate enough to represent the degree of elongation for rib-shaped features, which might be better represented by a length/thickness ratio. It has been found that the more curved the structure is, the lower the eccentricity.

Additionally and/or alternatively, one may define an effective degree of elongation as:

$${e}^{′} = \sqrt{1 - \frac{{A}^{2}}{{a}^{4}}}$$

where A is the area of the blob, and the minor axis length b of the eccentricity formula is replaced with A/a. The effective degree of elongation has been found to work better for rib shaped structures, although it is not an exact representation of the length/thickness ratio.

A plurality of the extracted blob features are used for blob level classification (see, image 58 in FIG. 11). By way of example, the following list may be employed to summarize the processes and features used for classification of the blobs and determinations of defect types.

For detecting and classifying a defect as a chip, it has been found that suitable results may be obtained by subjecting the image of the edge surface to a Haar (scale 3) filter, applying hysteresis thresholding to produce segments, and identifying blobs as those with relatively high averaged horizontal integration values. With such processing, the resultant extracted blob features would suggest a chip when one or more of: (i) a total area of a blob is relatively large, within a range of relatively small to relatively large, (ii) an eccentricity and/or elongation of a blob is relatively low, within a range of relatively low to relatively high, and (iii) a fill ratio of a blob is relatively high, within a range of relatively low to relatively high.

For detecting and classifying a defect as one or more hackle lines, it has been found that suitable results may be obtained by subjecting the image of the edge surface to a Haar (scale 1) filter, and applying a single lower-level threshold to produce segments. With such processing, the resultant extracted blob features would suggest one or more hackle lines when one or more of: (i) an effective width of the blob(s) is/are relatively small, within a range of relatively small to relatively large, and (ii) a location of the blob(s) is/are relatively close to a periphery of the edge surface of the glass ribbon 103A.

For detecting and classifying a defect as one or more Wallner lines, it has been found that suitable results may be obtained by subjecting the image of the edge surface to a Haar (scale 3) filter, and applying a single lower-level threshold to produce segments. With such processing, the resultant extracted blob features would suggest one or more Wallner lines when one or more of: (i) a total size (e.g., height, width and/or area) of the blob(s) is/are relatively large, within a range of relatively small to relatively large, and (ii) an eccentricity and/or elongation of the blob(s) is/are relatively high, within a range of relatively low to relatively high.

Additionally and/or alternatively, for detecting and classifying a defect as one or more Wallner lines, it has also been found that suitable results may be obtained by subjecting the image of the edge surface to a Haar (scale 3) filter, and applying an hysteresis threshold to produce segments. With such processing, the resultant extracted blob features would suggest one or more one or more Wallner lines when one or more of: (i) a total size (e.g., height, width and/or area) of the blob(s) is/are relatively large, within a range of relatively small to relatively large, (ii) an eccentricity and/or elongation of the blob(s) is/are relatively high, within a range of relatively low to relatively high, and (iii) a height of the blob(s) is/are relatively small, within a range of relatively small to relatively large.

For detecting and classifying a defect as one or more arrest lines, it has been found that suitable results may be obtained by subjecting the image of the edge surface to a Haar (scale 3) filter, applying hysteresis thresholding to produce segments, and identifying blobs as those with relatively high averaged horizontal integration values. With such processing, the resultant extracted blob features would suggest one or more arrest lines when one or more of: (i) a total area of the blob(s) is/are relatively large, within a range of relatively small to relatively large, (ii) an eccentricity and/or elongation of the blob(s) is/are relatively high, within a range of relatively low to relatively high, (iii) a width of the blob(s) is/are relatively small, within a range of relatively small to relatively large, and (iv) a height of the blob(s) is/are relatively large, within a range of relatively small to relatively large (for example a total height across 90% of the edge surface).

The above-noted features have been found to provide a relatively high level of separation between different defects and to perform fairly well at the blob-level. Notably, the hackle lines may produce high responses in both scale 1 and scale 3 Haar filtered images; however, the scale 3 filtered images have been found to possibly obscure the thin line-like features of hackle lines, and thus may result in a false classification as chips.

By way of example, reference is made to image 58 of FIG. 11, which illustrates the classification of the defects by type (chip, hackle lines, Wallner lines, and arrest lines) using shading (and/or color). The classification of defects in image 58 of FIG. 11 is shown by way of greyscale; however, during experimentation, the laboratory system produced an indication of the classification of defects by way of color. In any case, the greyscale key at the bottom of FIG. 11 is intended to show: minor defects using greyscale 60, unknown defects using greyscale 62, bright features using greyscale 64, dark features using greyscale 66, Wallner lines using greyscale 68, hackle lines using greyscale 70, arrest lines using greyscale 72, and chip defects using greyscale 72. Inasmuch as the resolution of the greyscale of FIG. 11 may be lower than optimum, one can envision that a color representation of the defects may be: minor defects using dark blue 60, unknown defects using medium blue 62, bright features using light blue 64, dark features using light green 66, Wallner lines using yellow 68, hackle lines using orange 70, arrest lines using bright red 72, and chip defects using brown 72. Irrespective of whether color or greyscale is employed, the defects of image 58 in FIG. 11 include chips, Wallner lines, and hackle lines.

In some cases, due to web motion or certain glass surface defects, portions of the edge surface of the glass ribbon 103A may not be well captured within the image. For example, a dark area on the edge surface may correspond to an out-of-focus region, where not enough photons are captured by the imaging sensor 184, while an overly bright region may suggest an inclined mirror surface. It is highly unlikely that some form of image processing will recover features in such areas, and thus it may be advantageous to map out these areas for future analysis. The algorithm herein may include a module to map out these areas using a global thresholding technique. It is desirable, however, that the module avoid the inclusion of background regions in the image because background regions also appear as dark regions. This may be difficult, since most defects exist on the periphery of the edge surfaces, thereby creating a very uneven surface for foreground extraction. In addition, diffraction on a corner of the edge surface and/or a flat surface may obscure the true boundary of the edge surface in the image. Furthermore, the edge surface may not be exactly horizontal, due slight distortions of the glass ribbon 103A or stress therein. To compensate for these effects, the algorithm herein introduces a new way to extract the sample area from the edge surface images using a user-defined thickness. It is assumed that the sample area of the edge surface is horizontally positioned within a small window, and thus one may implement a box matched filter, the height of which is the same as the given sample area thickness. The filtered image will have a local maximum along the Y-axis at the center of the sample area. With the calculated sample area center and user-defined thickness, the sample area may be successfully extracted. A global thresholding may then be carried out on the masked sample area to avoid inclusion of the background.

The grouping module may be employed to address the possibility that the segmentation module produces over-segmented blobs, especially for chips. After blob-level classification, it may be desirable to merge spatially close blobs to form logically more accurate representations of defects. Grouping of blobs is mostly used for hackle lines and chips (see, image 60 in FIG. 11).

For hackle lines, the algorithm herein provides for grouping and performing another level of classification, since one of the features of hackle lines is that they are spatially segregated. The grouping of hackle lines may be performed by iteratively looking at adjacent regions for each hackle line, which is based on the assumption that hackle lines appear segregated. Next, thresholds of width and height may be used to eliminate small segregations of hackle lines.

For chips, the algorithm herein also provides for grouping and performing another level of classification. The simplest form of a chip may include two blobs, each representing a “mirror” face and a “dark” face of a chip. In a real case, chips often appear in groups. It may be desirable to show a group of closely packed chips as one chip. In addition, certain adjacent defects, which are too small to be determined or classified under blob-level classification, may also be grouped with a chip to achieve a complete and logical segmentation. One issue in grouping is to determine whether a non-chip defect blob should be connected to a chip blob. Although possible, it is desirable not to use only spatial closeness as the rule of the grouping determination. Thus, the algorithm herein may operate on the assumption that a non-chip blob is connected to a chip blob when a predefined portion of the perimeter of the non-chip blob resides in the dilated chip blob. While other ways to define connectivity are also possible, it has been found that the foregoing approach is suitable for most cases. It may be desirable to iteratively connect undetermined areas, Wallner lines, and bright regions to form logically correct segmentation.

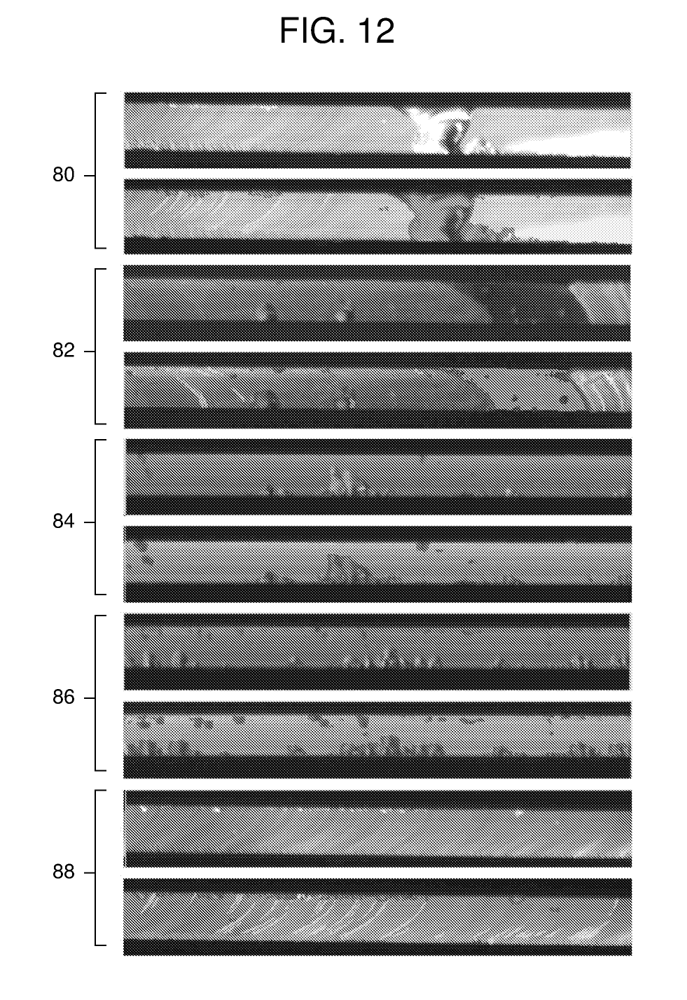

FIG. 12 is a collection of respective pairs of images, each pair including an image of an edge surface of a cut ribbon of glass, and an output image representing a classification of one or more detected and identified defects. Image 80 includes an edge surface image having a chip defect, hackle lines, and Wallner lines, and a resultant image according to the above-noted algorithm, which indicates such defects. Image 82 includes an edge surface image having hackle lines, Wallner lines, and arrest lines, and a resultant image according to the above-noted algorithm, which indicates such defects. Images 84 and 86 each include an edge surface image having chip defects, and a resultant image according to the above-noted algorithm, which indicates such defects. Image 88 includes an edge surface image having chips, hackle lines, and Wallner lines, and a resultant image according to the above-noted algorithm, which indicates such defects. The processing results are very promising, as the algorithm performed very well on the edge surface images.

Again, the images of FIG. 12 are intended to illustrate the classification of the defects by type (chip, hackle lines, Wallner lines, and arrest lines) using shading (and/or color). However, due to the limitations of the resolution of the images 80, 82, 84, 86, and 88, the skilled artisan may envision that a color representation of the defects may be: minor defects using dark blue, unknown defects using medium blue, bright features using light blue, dark features using light green, Wallner lines using yellow, hackle lines using orange, arrest lines using bright red, and chip defects using brown.

Although the disclosure herein has been described with reference to particular embodiments, it is to be understood that these embodiments are merely illustrative of the principles and applications of the embodiments herein. It is therefore to be understood that numerous modifications may be made to the illustrative embodiments and that other arrangements may be devised without departing from the spirit and scope of the present application. For example, the various features may be combined as set forth in the specific exemplary embodiments below.

### Embodiment 1

A method, comprising:
moving a glass web comprising a length and a width transverse to the length from a source to a destination in a transport direction along the length of the glass web;
cutting the glass web, at a cutting zone, along the length of the glass web into at least first and second glass ribbons as the glass web is moved in the transport direction from the source to the destination such that respective first and second edge surfaces are produced on the first and second glass ribbons; and
optically inspecting at least one of the first and second edge surfaces in real-time as the first and second glass ribbons are moved in the transport direction to the destination,
wherein the inspecting step includes: (i) taking at least one image of the at least one of the first and second edge surfaces as the first and second glass ribbons are moved in the transport direction, (ii) extracting one or more features of the at least one of the first and second edge surfaces from the at least one image, and (iii) detecting one or more defects, and identifying one or more types of the one or more defects based on the one or more extracted features.

### Embodiment 2

The method of embodiment 1, wherein the inspecting step includes:
directing incident light onto and through an opposing edge surface of at least one of the first and second glass ribbons that is laterally opposite to the at least one of the first and second edge surfaces;
propagating the light through the at least one of the first and second glass ribbons, transversely with respect to the transport direction, such that the light exits through the at least one of the first and second edge surfaces; and
directing an optical axis of an imaging sensor substantially perpendicularly toward the at least one of the first and second edge surfaces, to receive the light exiting the at least one of the first and second edge surfaces, such that the imaging sensor produces the at least one image.

### Embodiment 3

The method of embodiment 2, wherein the step of directing the imaging sensor toward the at least one of the first and second edge surfaces includes:
monitoring a distance from the imaging sensor and/or a reference position to the at least one of the first and second edge surfaces as the first and second glass ribbons of the glass web are moved in the transport direction to the destination; and
automatically adjusting a position of focus of the imaging sensor as a function of the distance such that the at least one image remains in focus.

### Embodiment 4

The method of any one of embodiments 1-3, wherein the step of detecting the one or more defects, and identifying the one or more types of the one or more defects, includes:
enhancing one or more defect features as compared to background features in the at least one image;
applying a segmentation process to the enhanced defect features to separate high contrast features from lower contrast features, thereby producing a plurality of segments; and
extracting features from each of the plurality of segments by analyzing each segment as to one or more of the following features:
(i) a total area of the segment,
(ii) an eccentricity and/or elongation of the segment,
(iii) a width of the segment,
(iv) a height of the segment, and
(v) a fill ratio of the segment.

### Embodiment 5

The method of embodiment 4, further comprising grouping at least some of the segments together to form at least one aggregated segment.

### Embodiment 6

The method of embodiment 4 or embodiment 5, further comprising determining and identifying the one or more types of the one or more defects based on the analysis of the segments.

### Embodiment 7

The method of embodiment 6, further comprising making a determination that one or more of the segments represents a chip when:
(i) a total area of the one or more segments is relatively large, within a range of relatively small to relatively large,
(ii) an eccentricity and/or elongation of the one or more segments is relatively low, within a range of relatively low to relatively high, and
(iii) a fill ratio of the one or more segments is relatively high, within a range of relatively low to relatively high.

### Embodiment 8

The method of embodiment 6, further comprising making a determination that one or more of the segments represent a hackle line when:
(i) a width of the one or more segments is relatively small, within a range of relatively small to relatively large, and
(ii) a location of the one or more segments is relatively close to a periphery of the edge surface.

### Embodiment 9

The method of embodiment 6, further comprising making a determination that one or more of the segments represent a Wallner line when:
(i) a total area of the one or more segments is relatively large, within a range of relatively small to relatively large,
(ii) an eccentricity and/or elongation of the one or more segments is relatively high, within a range of relatively low to relatively high, and
(iii) a height of the one or more segments is relatively small, within a range of relatively small to relatively large.

### Embodiment 10

The method of embodiment 6, further comprising making a determination that one or more of the segments represent an arrest line when:
(i) a total area of the one or more segments is relatively large, within a range of relatively small to relatively large,
(ii) an eccentricity and/or elongation of the one or more segments is relatively high, within a range of relatively low to relatively high,
(iii) a width of the one or more segments is relatively small, within a range of relatively small to relatively large, and
(iv) a height of the one or more segments is relatively large, within a range of relatively small to relatively large.

### Embodiment 11

The method of any one of embodiments 1-10, further comprising automatically adjusting one or more parameters of the step of cutting the glass web at the cutting zone based on the detection and identification, wherein
the step of cutting the glass web at the cutting zone includes heating an elongated zone of the glass web using a laser delivery apparatus followed by cooling the heated portion of the glass web to propagate a fracture in a direction opposite to the transport direction, thereby producing the first and second ribbons; and
the one or more parameters of the step of cutting the glass web include a power level of incident laser light from the laser delivery apparatus, and a focus of the incident laser light from the laser delivery apparatus.

### Embodiment 12

An apparatus, comprising:
a source apparatus configured to supply a glass web, the glass web having a length and a width transverse to the length;
a transport mechanism configured to move the glass web from the source apparatus to a destination in a transport direction along the length of the glass web; and
a cutting mechanism configured to cut the glass web, at a cutting zone, along the length into at least first and second glass ribbons as the glass web is moved in the transport direction from the source to the destination, such that respective first and second edge surfaces are produced on the first and second glass ribbons; and
an inspection mechanism configured to optically inspect at least one of the first and second edge surfaces in real-time as the first and second glass ribbons of the glass web are moved in the transport direction to the destination,
wherein the inspection mechanism is configured to execute actions, including: (i) taking at least one image of the at least one of the first and second edge surfaces as the first and second glass ribbons are moved in the transport direction, (ii) extracting one or more features of the at least one of the first and second edge surfaces from the at least one image, and (iii) detecting one or more defects, and identifying one or more types of the one or more defects, based on the one or more extracted features.

### Embodiment 13

The apparatus of embodiment 12, wherein the inspection mechanism comprises:
a light source configured to direct incident light onto and through an opposing edge surface of at least one of the first and second glass ribbons that is laterally opposite to the at least one of the first and second edge surfaces, such that the light propagates through the at least one of the first and second glass ribbons, transversely with respect to the transport direction, such that the light exits through the at least one of the first and second edge surfaces; and
an imaging sensor comprising an optical axis directed substantially perpendicularly toward the at least one of the first and second edge surfaces, and configured to receive the light exiting the at least one of the first and second edge surfaces, such that the imaging sensor produces the at least one image.

### Embodiment 14

The apparatus of embodiment 13, further comprising an automatic focus mechanism comprising:
a distance sensor configured to monitor a distance from the imaging sensor and/or a reference position to the at least one of the first and second edge surfaces as the first and second glass ribbons of the glass web are moved in the transport direction to the destination; and
a motion stage configured to automatically adjust a position of focus of the imaging sensor as a function of the varying distance such that the at least one image remains in focus.

### Embodiment 15

The apparatus of any one of embodiments 12-14, wherein the inspection mechanism includes a computer processor configured to operate under the control of a computer program, which when executed by the computer processor causes the computer processor to carry out the actions of detecting the one or more defects, and identifying the one or more types of the one or more defects, by:
enhancing one or more defect features as compared to background features in the at least one image;
applying a segmentation process to the enhanced defect features to separate high contrast features from lower contrast features, thereby producing a plurality of segments; and
extracting features from each of the plurality of segments by analyzing each segment as to one or more of the following features:
(i) a total area of the segment,
(ii) an eccentricity and/or elongation of the segment,
(iii) a width of the segment,
(iv) a height of the segment, and
(v) a fill ratio of the segment.

### Embodiment 16

The apparatus of embodiment 15, wherein the inspection mechanism is further configured to carry out an action of grouping at least some of the segments together to form at least one aggregated segment.

### Embodiment 17

The apparatus of embodiment 15 or embodiment 16, wherein the inspection mechanism is further configured to carry out an action of determining and identifying the one or more types of the one or more defects based on the analysis of the segments.

### Embodiment 18

The apparatus of embodiment 17, wherein the inspection mechanism is further configured to carry out an action of making a determination that one or more of the segments represent a chip when:
(i) a total area of the one or more segments is relatively large, within a range of relatively small to relatively large,
(ii) an eccentricity and/or elongation of the one or more segments is relatively low, within a range of relatively low to relatively high, and
(iii) a fill ratio of the one or more segments is relatively high, within a range of relatively low to relatively high.

### Embodiment 19

The apparatus of embodiment 17, wherein the inspection mechanism is further configured to carry out an action of making a determination that one or more of the segments represent a hackle when:
(i) a width of the one or more segments is relatively small, within a range of relatively small to relatively large, and
(ii) a location of the one or more segments is relatively close to a periphery of the edge surface.

### Embodiment 20

The apparatus of embodiment 17, wherein the inspection mechanism is further configured to carry out an action of making a determination that one or more of the segments represent a Wallner line when:
(i) a total area of the one or more segments is relatively large, within a range of relatively small to relatively large,
(ii) an eccentricity and/or elongation of the one or more segments is relatively high, within a range of relatively low to relatively high, and
(iii) a height of the one or more segments is relatively small, within a range of relatively small to relatively large.

### Embodiment 21

The apparatus of embodiment 17, wherein the inspection mechanism is further configured to carry out an action of making a determination that one or more of the segments represent an arrest line when:
(i) a total area of the one or more segments is relatively large, within a range of relatively small to relatively large,
(ii) an eccentricity and/or elongation of the one or more segments is relatively high, within a range of relatively low to relatively high,
(iii) a width of the one or more segments is relatively small, within a range of relatively small to relatively large, and
(iv) a height of the one or more segments is relatively large, within a range of relatively small to relatively large.

### Embodiment 22

The apparatus of any one of embodiments 12-21, further comprising a feedback mechanism configured to automatically adjust one or more parameters of the cutting mechanism and of cutting the glass web at the cutting zone based on the detection and identification, and wherein
the cutting mechanism includes a laser delivery apparatus configured to heat an elongated zone of the glass web and a cooling fluid source configured to cool the heated portion of the glass web to propagate a fracture in a direction opposite to the transport direction and cut the glass web, thereby producing the first and second ribbons; and
the one or more parameters of the cutting mechanism include a power level of incident laser light from the laser delivery apparatus, and a focus of the incident laser light from the laser delivery apparatus.

1. A method, comprising:
moving a glass web comprising a length and a width transverse to the length from a source to a destination in a transport direction along the length of the glass web;
cutting the glass web, at a cutting zone, along the length of the glass web into at least first and second glass ribbons as the glass web is moved in the transport direction from the source to the destination such that respective first and second edge surfaces are produced on the first and second glass ribbons; and
optically inspecting at least one of the first and second edge surfaces in real-time as the first and second glass ribbons are moved in the transport direction to the destination,
wherein the inspecting step includes: (i) taking at least one image of the at least one of the first and second edge surfaces as the first and second glass ribbons are moved in the transport direction, (ii) extracting one or more features of the at least one of the first and second edge surfaces from the at least one image, and (iii) detecting one or more defects, and identifying one or more types of the one or more defects based on the one or more extracted features.

2. The method of claim 1, wherein the inspecting step includes:
directing incident light onto and through an opposing edge surface of at least one of the first and second glass ribbons that is laterally opposite to the at least one of the first and second edge surfaces;
propagating the light through the at least one of the first and second glass ribbons, transversely with respect to the transport direction, such that the light exits through the at least one of the first and second edge surfaces; and
directing an optical axis of an imaging sensor substantially perpendicularly toward the at least one of the first and second edge surfaces, to receive the light exiting the at least one of the first and second edge surfaces, such that the imaging sensor produces the at least one image.

3. The method of claim 2, wherein the step of directing the imaging sensor toward the at least one of the first and second edge surfaces includes:
monitoring a distance from the imaging sensor and/or a reference position to the at least one of the first and second edge surfaces as the first and second glass ribbons of the glass web are moved in the transport direction to the destination; and
automatically adjusting a position of focus of the imaging sensor as a function of the distance such that the at least one image remains in focus.

4. The method of claim 1, wherein
the step of detecting the one or more defects, and identifying the one or more types of the one or more defects, includes:
enhancing one or more defect features as compared to background features in the at least one image;
applying a segmentation process to the enhanced defect features to separate high contrast features from lower contrast features, thereby producing a plurality of segments; and
extracting features from each of the plurality of segments by analyzing each segment as to one or more of the following features:
(i) a total area of the segment,
(ii) an eccentricity and/or elongation of the segment,
(iii) a width of the segment,
(iv) a height of the segment, and
(v) a fill ratio of the segment.

5. The method of claim 4, further comprising grouping at least some of the segments together to form at least one aggregated segment.

6. The method of claim 4, further comprising determining and identifying the one or more types of the one or more defects based on the analysis of the segments.

7. The method of claim 6, further comprising making a determination that one or more of the segments represents a chip when:
(i) a total area of the one or more segments is relatively large, within a range of relatively small to relatively large,
(ii) an eccentricity and/or elongation of the one or more segments is relatively low, within a range of relatively low to relatively high, and
(iii) a fill ratio of the one or more segments is relatively high, within a range of relatively low to relatively high.

8. The method of claim 6, further comprising making a determination that one or more of the segments represent a hackle line when:
(i) a width of the one or more segments is relatively small, within a range of relatively small to relatively large, and
(ii) a location of the one or more segments is relatively close to a periphery of the edge surface.

9. The method of claim 6, further comprising making a determination that one or more of the segments represent a Wallner line when:
(i) a total area of the one or more segments is relatively large, within a range of relatively small to relatively large,
(ii) an eccentricity and/or elongation of the one or more segments is relatively high, within a range of relatively low to relatively high, and
(iii) a height of the one or more segments is relatively small, within a range of relatively small to relatively large.

10. The method of claim 6, further comprising making a determination that one or more of the segments represent an arrest line when:
(i) a total area of the one or more segments is relatively large, within a range of relatively small to relatively large,
(ii) an eccentricity and/or elongation of the one or more segments is relatively high, within a range of relatively low to relatively high,
(iii) a width of the one or more segments is relatively small, within a range of relatively small to relatively large, and
(iv) a height of the one or more segments is relatively large, within a range of relatively small to relatively large.

11. The method of claim 1, further comprising automatically adjusting one or more parameters of the step of cutting the glass web at the cutting zone based on the detection and identification, wherein
the step of cutting the glass web at the cutting zone includes heating an elongated zone of the glass web using a laser delivery apparatus followed by cooling the heated portion of the glass web to propagate a fracture in a direction opposite to the transport direction, thereby producing the first and second ribbons; and
the one or more parameters of the step of cutting the glass web include a power level of incident laser light from the laser delivery apparatus, and a focus of the incident laser light from the laser delivery apparatus.

12. An apparatus, comprising:
a source apparatus configured to supply a glass web, the glass web having a length and a width transverse to the length;
a transport mechanism configured to move the glass web from the source apparatus to a destination in a transport direction along the length of the glass web; and
a cutting mechanism configured to cut the glass web, at a cutting zone, along the length into at least first and second glass ribbons as the glass web is moved in the transport direction from the source to the destination, such that respective first and second edge surfaces are produced on the first and second glass ribbons; and
an inspection mechanism configured to optically inspect at least one of the first and second edge surfaces in real-time as the first and second glass ribbons of the glass web are moved in the transport direction to the destination,
wherein the inspection mechanism is configured to execute actions, including: (i) taking at least one image of the at least one of the first and second edge surfaces as the first and second glass ribbons are moved in the transport direction, (ii) extracting one or more features of the at least one of the first and second edge surfaces from the at least one image, and (iii) detecting one or more defects, and identifying one or more types of the one or more defects, based on the one or more extracted features.

13. The apparatus of claim 12, wherein the inspection mechanism comprises:
a light source configured to direct incident light onto and through an opposing edge surface of at least one of the first and second glass ribbons that is laterally opposite to the at least one of the first and second edge surfaces, such that the light propagates through the at least one of the first and second glass ribbons, transversely with respect to the transport direction, such that the light exits through the at least one of the first and second edge surfaces; and
an imaging sensor comprising an optical axis directed substantially perpendicularly toward the at least one of the first and second edge surfaces, and configured to receive the light exiting the at least one of the first and second edge surfaces, such that the imaging sensor produces the at least one image.

14. The apparatus of claim 13, further comprising an automatic focus mechanism comprising:
a distance sensor configured to monitor a distance from the imaging sensor and/or a reference position to the at least one of the first and second edge surfaces as the first and second glass ribbons of the glass web are moved in the transport direction to the destination; and
a motion stage configured to automatically adjust a position of focus of the imaging sensor as a function of the varying distance such that the at least one image remains in focus.

15. The apparatus of claim 12, wherein the inspection mechanism includes a computer processor configured to operate under the control of a computer program, which when executed by the computer processor causes the computer processor to carry out the actions of detecting the one or more defects, and identifying the one or more types of the one or more defects, by:
enhancing one or more defect features as compared to background features in the at least one image;
applying a segmentation process to the enhanced defect features to separate high contrast features from lower contrast features, thereby producing a plurality of segments; and
extracting features from each of the plurality of segments by analyzing each segment as to one or more of the following features:
(i) a total area of the segment,
(ii) an eccentricity and/or elongation of the segment,
(iii) a width of the segment,
(iv) a height of the segment, and
(v) a fill ratio of the segment.

16. The apparatus of claim 15, wherein the inspection mechanism is further configured to carry out an action of grouping at least some of the segments together to form at least one aggregated segment.

17. The apparatus of claim 15, wherein the inspection mechanism is further configured to carry out an action of determining and identifying the one or more types of the one or more defects based on the analysis of the segments.

18. The apparatus of claim 17, wherein the inspection mechanism is further configured to carry out an action of making a determination that one or more of the segments represent a chip when:
(i) a total area of the one or more segments is relatively large, within a range of relatively small to relatively large,
(ii) an eccentricity and/or elongation of the one or more segments is relatively low, within a range of relatively low to relatively high, and
(iii) a fill ratio of the one or more segments is relatively high, within a range of relatively low to relatively high.

19. The apparatus of claim 17, wherein the inspection mechanism is further configured to carry out an action of making a determination that one or more of the segments represent a hackle when:
(i) a width of the one or more segments is relatively small, within a range of relatively small to relatively large, and
(ii) a location of the one or more segments is relatively close to a periphery of the edge surface.

20. The apparatus of claim 17, wherein the inspection mechanism is further configured to carry out an action of making a determination that one or more of the segments represent a Wallner line when:
(i) a total area of the one or more segments is relatively large, within a range of relatively small to relatively large,
(ii) an eccentricity and/or elongation of the one or more segments is relatively high, within a range of relatively low to relatively high, and
(iii) a height of the one or more segments is relatively small, within a range of relatively small to relatively large.

21. The apparatus of claim 17, wherein the inspection mechanism is further configured to carry out an action of making a determination that one or more of the segments represent an arrest line when:
(i) a total area of the one or more segments is relatively large, within a range of relatively small to relatively large,
(ii) an eccentricity and/or elongation of the one or more segments is relatively high, within a range of relatively low to relatively high,
(iii) a width of the one or more segments is relatively small, within a range of relatively small to relatively large, and
(iv) a height of the one or more segments is relatively large, within a range of relatively small to relatively large.

22. The apparatus of claim 12, further comprising a feedback mechanism configured to automatically adjust one or more parameters of the cutting mechanism and of cutting the glass web at the cutting zone based on the detection and identification, and wherein
the cutting mechanism includes a laser delivery apparatus configured to heat an elongated zone of the glass web and a cooling fluid source configured to cool the heated portion of the glass web to propagate a fracture in a direction opposite to the transport direction and cut the glass web, thereby producing the first and second ribbons; and
the one or more parameters of the cutting mechanism include a power level of incident laser light from the laser delivery apparatus, and a focus of the incident laser light from the laser delivery apparatus.
